(19) United States
(12) Patent Application Publication
(10) Pub. No.: US 2017/0288944 A1
(43) Pub. Date: Oct. 5, 2017

(54) ACTION ANALYTICS AND NOTIFICATION

(71) Applicant: International Business Machines Corporation, Armonk, NY (US)

(72) Inventors: Laura I. Rusu, Victoria (AU); Gandhi Sivakumar, Melbourne (AU); Ziyuan Wang, Melbourne (AU)

(21) Appl. No.: 15/086,718

(22) Filed: Mar. 31, 2016

(51) Int. Cl. H04L 12/24; H04L 29/08

(52) U.S. Cl. CPC H04L 41/0604; H04L 67/22; H04L 67/10

(57) ABSTRACT

Embodiments include method, systems and computer program products for action analytics and notification. Aspects include receiving, by a processor, data comprising user data, rules data, and external data; analyzing, by the processor, the data to generate an alert notification; and mapping the alert notification to at least one of a plurality of user devices based upon a device type of the at least one of the plurality of user devices.

### BACKGROUND

The present disclosure relates to action analytics and, more specifically, to methods and systems for analyzing activities and generating alert notifications.

Today, managing the day to day activities that are necessary to keep up with our fast paced lives has become increasingly difficult due to the increased number of tasks for which we are responsible. In the past, attending a business meeting simply consisted of showing up on time to discuss the topics of the meeting. Today, an increasingly large number of emails, phone calls, and schedule changes have made it near impossible to focus on the important parts of the meeting because of the constant changing information being thrown at a person. In addition to work related data being sent to a person, external data is available that influences a person's behavior such as weather data, traffic data, and travel data.

A solution is needed to assist a person with day to day tasks that take into account a person's preferences as well as external influences that will affect a person's schedule to perform their day to day tasks.

### SUMMARY

Embodiments include a computer system for action analytics and notification, the computer system for a proximity feedback for medicine identification having a process, the processor configured to perform a method. The method includes receiving, by a processor, data comprising user data, rules data, and external data; analyzing, by the processor, the data to generate an alert notification; and mapping the alert notification to at least one of a plurality of user devices based upon a device type of the at least one of the plurality of user devices.

Embodiments also include a computer program product for action analytics and notification, the computer program product including a non-transitory computer readable storage medium having computer readable program code embodied therewith. The computer readable program code including computer readable program code configured to perform a method. The method includes receiving data, the data comprising user data, rules data, and external data; analyzing the data to generate an alert notification; and mapping the alert notification to at least one of a plurality of user devices based upon a device type of the at least one of the plurality of user devices.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for action analytics and notification in accordance with one or more embodiments; and

FIG. 5 illustrates a flow diagram of a method for action analytics and notification in accordance with one or more embodiments.

### DETAILED DESCRIPTION

In accordance with exemplary embodiments of the disclosure, methods, systems and computer program products for action analytics and notification are provided. In one or more exemplary embodiments, methods for action analytics with notifications include receiving data regarding an event which requires a set of tasks be completed for the event. In addition to the data received regarding the event, rules data and external data are collected and analyzed to generate an alert notification for the set of tasks to be completed for the event. The alert notification is then sent to one or more devices for the user to notify the user that a task needs to be complete. The alert notification is generated based on the user data, rules data, and external data.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

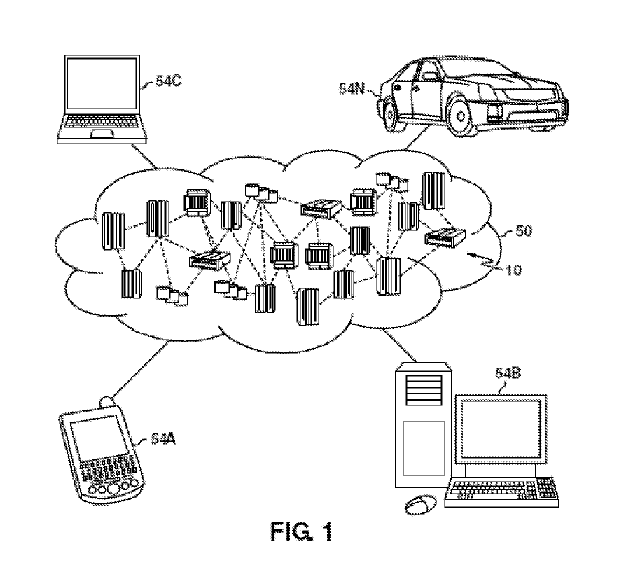

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

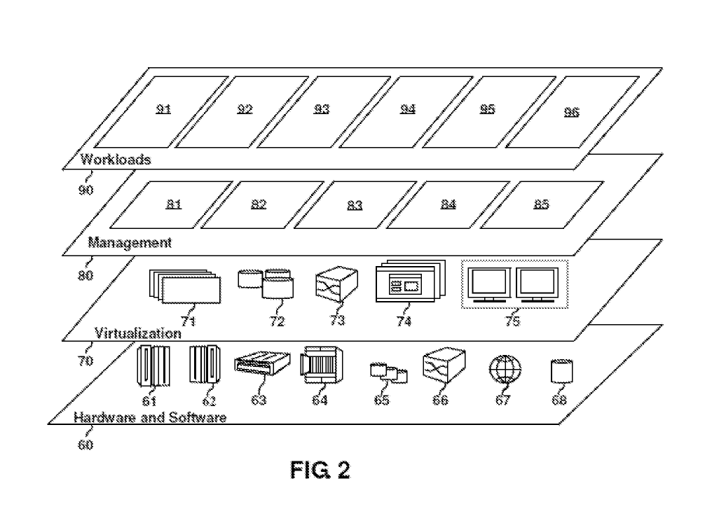

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and action analytics and notifications 96.

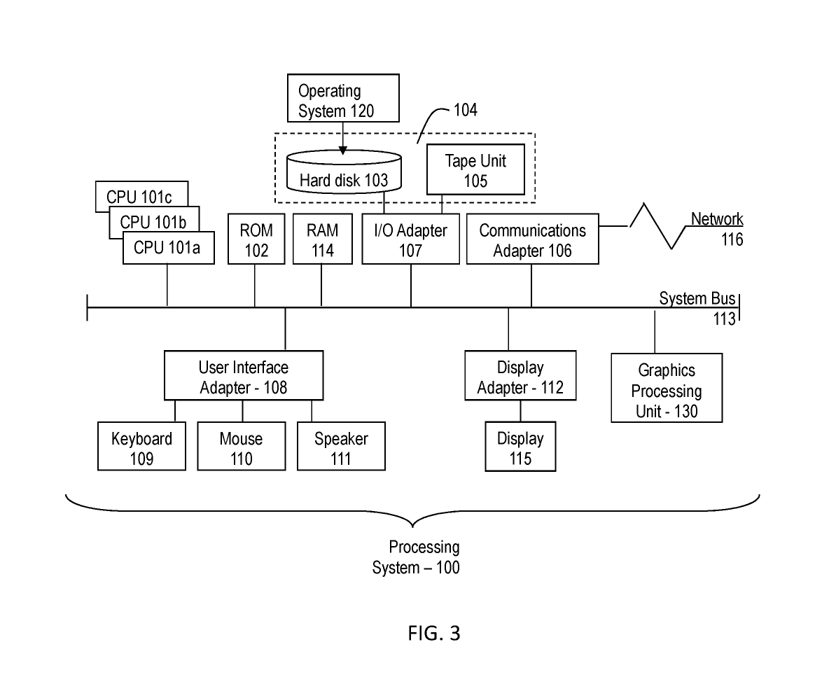

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

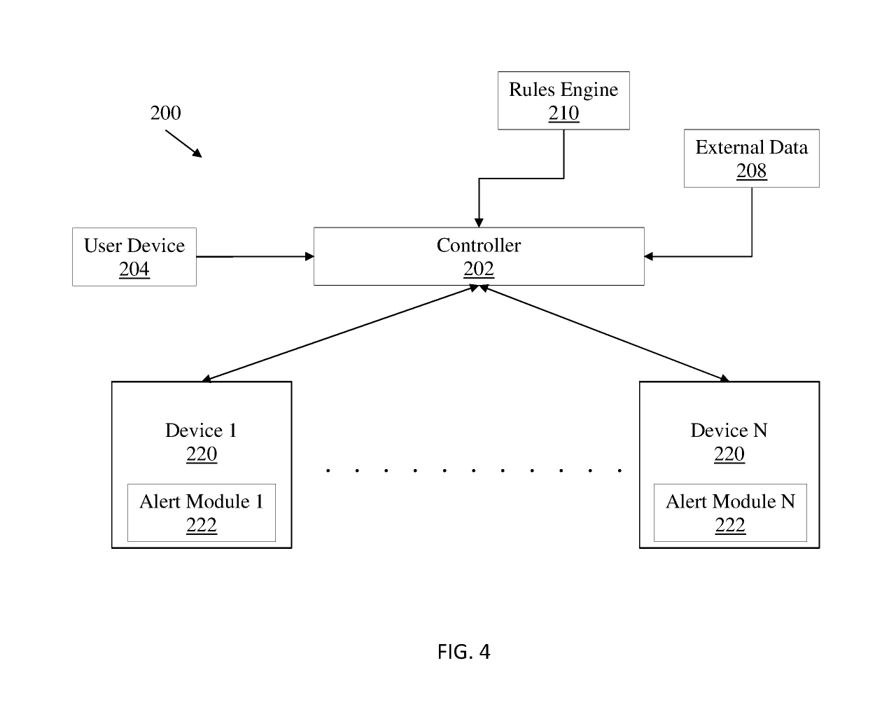

Referring to FIG. 4 there is shown a system 200 for action analytics and notification according to one or more embodiments. The system 200 includes a controller 202, user devices 204, external data 208, a rules engine 210, one or more devices 220, and one or more alert modules 222. In one or more embodiments, some or all of the functionality of the system 200 shown in FIG. 4 may be implemented by the node 10 of the cloud computing system 50 shown in FIG. 1, as well as the workloads layer 90 shown in FIG. 2.

In one or more embodiments, the controller 202 can be implemented on the processing system 100 found in FIG. 3. The controller 202 is configured to receive data from the user device 204. The data from the user device 204 can be information about an upcoming event or task that needs to be completed. For example, a user may provide the controller 202 with information related to an upcoming international trip. This international trip may fall into an activity type or category, such as a personal category or a work category, depending on whether this is a work international trip or a personal international trip. For the international trip, a multitude of tasks are involved which can include tasks such as packing luggage by a certain time, making car rental reservations by a certain time, packing proper medications, obtaining necessary travel documents such a visas, and making and/or confirming flight and hotel reservations. In exemplary embodiments, the user can input this data via the user device 204 into the controller 202 directly. In one embodiment, some of the data can be extracted from the user device 204 and provided to the controller 202 in a manner that is transparent to the user. For example, the user device 202 may be a smartphone that includes an application for an airline or hotel that contains the travel related information. These applications can be configured to share this data with the controller 202.

The controller 202 is also configured to receive rules data from a rules engine 210 and external data 208 from external sources. In various embodiments, the rules engine 210 may be set by the user or may be pre-programmed. For example, a user may set up a rules engine that specifies how and when a user wants to be notified for specific tasks or subtasks, i.e. a user may wish to be reminded to charge a device, such as a tablet, at least four hours before a departure time. The external data 208 can be taken from multiple sources such as weather, travel and traffic websites or news feeds. The external data 208 can include weather data, travel data, and traffic data.

The controller 202 is further configured to analyze the data from the user device 204, rules engine 210 and external data 208 to generate an alert. This alert can be sent to a device 220 and activated via an alert module 222. The alert module 222 can activate an alert in the form of a haptic, audio or visual signal. For example, a cell phone may receive the alert notification and the alert module on the cell phone would activate a vibration for the cell phone to alert the person carrying the device. The alert module 222 can be located on the device or can be in electric communication with the device but physically separate. For example, a device 220 such as a smart phone may be in electronic communication with a hands free headphone that receives the alert notification.

A user can specify, in the rules engine 210, preferences for certain types of alerts for a task. For example, revisiting the international trip scenario, a user may prefer to receive a reminder to charge certain devices such as a phone or tablet four hours before the flight takes off so that these devices would be available to use during the flight. The alert type may be an audio signal as specified by the user or may include multiple signals (audio, visual, and haptic) to multiple devices 220 to notify the user.

In one or more embodiments, the user device 204 may be a smart phone, smart watch, desktop or laptop computer, or any internet enabled device. The user device 204 can be one of the devices 220 with an alert module 222. Or the user device 204 may not have an alert module 222 and only be used to input user data. The controller 202 can also receive data from a device 220 as well as send alert notifications to the device 220. In one or more embodiments, the controller 202 can pull data from an indirect source on the user device 204 or other device 220. For example, a user may set a reminder on their cell phone and the controller 202 can pull that reminder data from the phone and generate an alert notification that can be sent to either the phone (i.e. user device 204) or sent to another device 220 such as an alert to a smartwatch or tablet. In another example, a calendar program on a user device 204 or other device 220 may contain scheduling or tasks data that a controller 202 can pull data. In one or more embodiments, the controller 202 can pull data from a task list application or a to-do list application on a user device 204 or other device 220. This data can be analyzed and compared to the rules engine 210 data and the external data 208 to develop and send alert notifications to the user device 204 or other device 220.

In one or more embodiments, the external data 208 can be taken from various web sites and news feeds regarding topics related to the tasks or events found in the user data. For example, for international travel, a major task is getting to the local airport on time for the flight. External data 208 can pull from a traffic monitoring feed or website to adjust the alert notifications to the user if traffic is particularly heavy. The user may be alerted to this change in the conditions so that the user can make appropriate adjustments to either the route to the airport or to the time at which the user leaves to go to the airport. Additional external data 208 may comprise travel related data such as flight delays or cancellations or unusual circumstances at the airport such as long lines at the security check points which will affect when a user would plan to leave to go to the airport. With traffic or travel delays, an alert notification would be generated and sent to the user to inform them of any changes that might affect their schedule of tasks. In an additional embodiment, the external data 208 can determine the type of device 220 the alert notification is sent and the type of alert notification. For example, external data 208 regarding the weather may generate an alert to a user's phone or a user's smartwatch to notify the user of potential for rain. The alert can be an audio signal which makes a sound to imitate rain or thunder to indicate to the user the need to bring an umbrella or a rain coat.

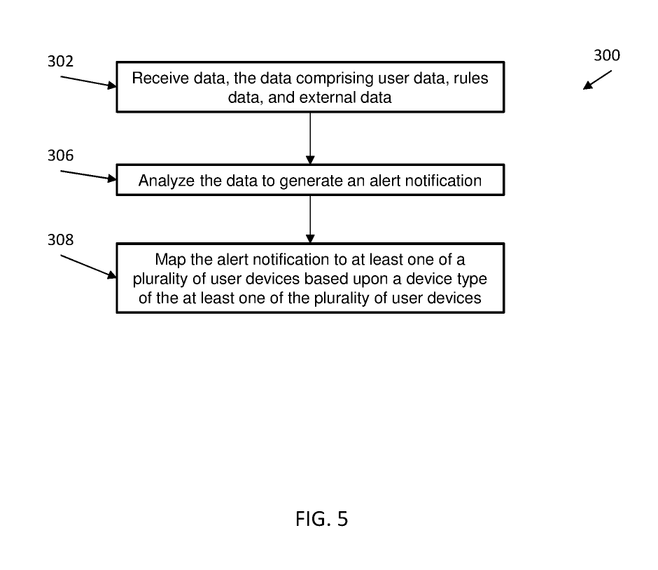

Referring now to FIG. 5 there is shown a flow diagram of a method 300 for action analytics and notification according to one or more embodiments. The method 300 includes receiving data, the data comprising user data, rules data, and external data, as shown at block 302. As shown at block 306, the method 300 analyzes the data to generate an alert notification. The method 300 also includes mapping the alert notification to at least one of a plurality of user devices based on a device type of the at least one of the plurality of user devices, as shown at block 308.

Additional processes may also be included. It should be understood that the processes depicted in FIG. 5 represent illustrations, and that other processes may be added or existing processes may be removed, modified, or rearranged without departing from the scope and spirit of the present disclosure.

In one or more exemplary embodiments, a set of tasks can be communicated to the controller 202 for an individual or a group of individuals via a user device 204. For example, if a family is travelling internationally, group activities that involve one or more family members can be communicated to the controller 202. Any family member can input a set of tasks for this international trip via a smart phone or tablet. The controller 202 can analyze the tasks and use the rules engine 210 to generate specific alert notifications to one or more of the family members. If a family member has specific medical needs, an alert notification can be generated and sent to a centralized home announcement system which may then output an audio or visual signal notifying the individual to ensure packing of a certain medication. In addition, a centralized home announcement system can output audio or visual signals to any or all of the family members to perform certain tasks in preparation for the international travel. In addition to a centralized announcement system within a home, the controller 202 can send individual alert notifications to a user device 204 that is personal to a specific family member such as a phone, laptop or tablet. Multiple alert notifications can be sent for a task as a reminder to complete the task. For example, a user may want three notifications to perform a task that is considered of high importance to be received at different times before a task completion deadline. A user may want an alert one hour before the deadline, thirty minutes before the deadline, and fifteen minutes before deadline. If the user has completed the task, the user can notify the controller 202 that the task is complete via a user device 204 such as their smart phone. For example, the alert notification may require the user to acknowledge receipt of the notification and even indicate completion of the task for the alert notification to stop being sent. The alert notification may have a “snooze” function that allows a user to delay completing a task and receive another alert notification after a certain amount of time has passed.

In one or more exemplary embodiments, a user may book a travel ticket online to travel via airplane to a destination. A confirmation email regarding the ticket and booking information may be sent to the user's laptop or smartphone. The controller 202 can pull information from this email about the booking or the user can send the email to the controller 202. In one or more embodiments, the user may specify in the rules engine 210, a set of tasks that need to be completed for a particular booking or the user may have a predefined list of tasks for all travel. In one or more embodiments, the controller 202 can learn from previous tasks inputted by the user into the rules engine to develop tasks automatically based upon the information regarding the booking. For example, if a user travels to a certain destination for business on multiple occasions, the controller 202 can receive the user data from a calendar application or from an email confirming a flight booking to develop tasks that were previously inputted by the user in the rules engine 210. In one or more exemplary embodiments, a set of tasks may include packing a suitcase, packing a briefcase for work, charging a cell phone or tablet, and taking or packing a medication. The alert notifications can be customized by the user for various devices 220 that receive alert notifications. For example, a user may receive an audio alert to a laptop or smartphone with a travel itinerary. Or a user may receive a vibration from a smartwatch indicating a time to leave for the airport. In this example, the controller 202 maps the alert notification to either the user device 204 or other devices 220 based upon which device the user is more likely to receive the alert notification. The alert notification for the task of packing a suitcase would not benefit the user if the alert notification was mapped to and sent to the computer system in the user's car or to the user's work computer. The controller 202, based upon the type of data received, i.e. external data 208 or rules engine 210, would map the alert notification to a device 220 that the user was near or would be likely to see around the time the alert would need to be sent. For example, if a task must be completed by a user while the user is at work, the alert notification would be mapped to a device located at or near the user's work at a time when the user was scheduled to be at work.

In one or more embodiments, external data 208 such as weather data may be analyzed by the controller 202 to develop alerts specific to the user. If there is a change in the weather of the trip destination, the user may receive an alert notification to pack an umbrella or a heavy coat should there be rain or snow. External data 208 such as traffic data may generate an alert to the user to indicate the user must leave earlier than planned due to a change in traffic patterns to the airport. For example, the controller 202 may receive external data 208 on a periodic basis regarding traffic, weather, and travel data. The alert notifications for each of the tasks to the user will change based on this data. Flight delays, as well as weather and traffic delays, can alter the leave for the airport task alert notification timing.

In one or more embodiments, the external data 208 can include email or calendar data received by the user. The controller 202 can be configured to receive updates/changes regarding events and tasks. For example, if the user is travelling for business, a change in the user's calendar event would be received by the controller 202 and any alert notifications tied to the task on the calendar would change. If a user has a meeting scheduled for 1 pm that gets moved to 2 pm, an alert notification for the user may be generated to first inform the user of the change and also modify future alert notification for tasks related to the calendar event (i.e., the business meeting).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for action analytics and notification, the method comprising:
receiving, by a processor, data comprising user data, rules data, and external data;
analyzing, by the processor, the data to generate an alert notification; and
mapping the alert notification to at least one of a plurality of user devices based upon a device type of the at least one of the plurality of user devices.

2. The method according to claim 1, further comprising sending the alert notification to the at least one of the plurality of user devices.

3. The method according to claim 2, wherein the user data is received from a first user device of the at least one of the plurality of user devices and the alert notification is sent to a second user device of the plurality of user devices.

4. The method according to claim 1, wherein the external data comprises at least one of weather data, traffic data, and travel data.

5. The method according to claim 1, wherein the alert notification is at least one of a haptic, an audio, and a visual signal.

6. The method according to claim 1, wherein the user data comprises at least one activity type.

7. The method according to claim 6, wherein the activity type includes one of a personal category and a work category.

8. The method according to claim 1, wherein the user data is taken from indirect sources, wherein indirect sources comprise at least one of a calendar application, a task list application, and a to-do list application.

9. The method according to claim 1, wherein the alert notification is designated by a user of the at least one of the plurality of user devices.

10. A system for action analytics and notification, the system comprising:
a memory; and
a processor communicatively coupled to the memory, wherein the processor is configured to:
receive data, the data comprising user data, rules data, and external data;
analyze the data to generate an alert notification; and
map the alert notification to at least one of a plurality of user devices based upon a device type of the at least one of the plurality of user devices.

11. The system of claim 10, wherein the processor is further configured to send the alert notification to the at least one of the plurality of user devices.

12. The system of claim 11, wherein the user data is received from a first user device of the at least one of the plurality of user devices and the alert notification is sent to a second user device of the plurality of user devices.

13. The system of claim 10, wherein the external data comprises at least one of a weather data, traffic data, and travel data.

14. The system of claim 10, wherein the alert notification is at least one of a haptic, an audio, and a visual signal.

15. The system of claim 10, wherein the user data comprises at least one activity type.

16. The system of claim 10, wherein the user data is taken from indirect sources, wherein indirect sources comprise at least one of a calendar application, a task list application, and a to-do list application.

17. The system of claim 10, wherein the alert notification is designated by a user of the at least one of the plurality of user devices.

18. A computer program product for action analytics and notification, the computer program product comprising a computer readable storage medium having program instructions embodied therewith, wherein the computer readable storage medium is not a transitory signal per se, the program instructions executable by a processor to cause the processor to perform a method comprising:
receiving data, the data comprising user data, rules data, and external data;
analyzing the data to generate an alert notification; and
mapping the alert notification to at least one of a plurality of user devices based upon a device type of the at least one of the plurality of user devices.

19. The computer program product of claim 18, further comprising: sending the alert notification to the at least one of the plurality of user devices.

20. The computer program product of claim 19, wherein the user data is received from a first user device of the at least one of the plurality of user devices and the alert notification is sent to a second user device of the plurality of user devices.
